(19) United States
(12) Patent Application Publication
(10) Pub. No.: US 2012/0266128 A1
(43) Pub. Date: Oct. 18, 2012

(54) COLLABORATIVE DEVELOPMENT SUPPORT SYSTEM, COLLABORATIVE DEVELOPMENT SUPPORT METHOD AND RECORDING MEDIUM

(75) Inventor: Daishi Kato, Minato-ku (JP)

(73) Assignee: NEC CORPORATION, Tokyo (JP)

(21) Appl. No.: 13/508,069

(22) PCT Filed: Nov. 5, 2010
(86) PCT No.: PCT/JP2010/069751

§ 371 Date: Jul. 2, 2012

(30) Foreign Application Priority Data
Nov. 5, 2009 (JP) 2009-253726

(51) Int. Cl. G06F 9/44

(52) U.S. Cl. 717/101

(57) ABSTRACT

Disclosed is a collaborative development support system that is provided with an information acquisition unit for acquiring operation history information as well as identification code information; a dividing unit for dividing the operation history information into operation groups, each being a set of consecutive operations according to a predetermined condition; a calculation unit for setting as an index at least one of a speed at which the input device was operated, a correction operations that is an action for correcting an operation of an operator and an operation including an invalid operation that is not accompanied by an input, and calculating a degree of familiarity represented by the index for each of the operation groups divided by the dividing unit; and a storage unit for associating the identification code information and the operation history information with the degree of familiarity and storing the same into an operation history database.

### TECHNICAL FIELD

The present invention relates to a collaborative development support system, a collaborative development support method and a recording medium, more specifically, a collaborative development support system, a collaborative development support method and a recording medium for more than one person to collaboratively develop a software.

### BACKGROUND ART

In developing a software, an operator in charge of the development has to master programming technology in order to develop a computer program. This programming technology can be basically mastered through learning, but a degree of familiarity with the technology such as how to use a programming language and a library function varies depending on an operator. In a complicated development and a large-scale development, a degree of familiarity with the technology varies among operators for collaborative development and for partial development. Consequently, it is important that an operator with a high degree of familiarity supports an operator with a low degree of familiarity.

For example, Patent Literature 1 describes a document management system in which a series of operation history group performed based on the user's intention can be extracted through a small amount of processing from a massive amount of operation history that randomly occurs and accumulates. In the document management system, the accumulated operation history is divided into small history sequences, each being for each user and being arranged in chronological order within a predetermined timewise range.

Patent Literature 2 describes a data processing system that can offer a precise advice to a user who has operation trouble by performing a predetermined processing to know an operation tendency of the user on the basis of the user's operation history.

Patent Literature 3 describes an operation assistance method: including monitoring a user's operation, estimating a suitable operation if an erroneous operation is determined, and providing a method to assist the user's operation.

Patent Literature 4 describes an art to reduce a difficulty to specify a related participant in a system in which a plurality of participants coedit a document. The art includes analyzing an operation history of a user and specifying the related participant from an operation history stored in an operation history storage unit on the basis of a predetermined condition.

Patent Literature 5 describes a method including: storing personal parameters of persons assigned to a type of job, and when receiving a job request, automatically sending a processing request to a person who is determined to be suitable for the job.

Patent Literature 6 describes a method for providing a technical support via a communication network. For example, a purchaser of a product or a service can execute a computer program to establish an intelligently routed support request to a person having knowledge of a particular product.

### PRIOR ART

### Patent Literature

patent Literature 1: Unexamined Japanese Patent Application Kokai Publication No. 2000-172696
Patent Literature 2: Unexamined Japanese Patent Application Kokai Publication No. 2003-177847
Patent Literature 3: Unexamined Japanese Patent Application Kokai Publication No. 2003-345487
Patent Literature 4: Unexamined Japanese Patent Application Kokai Publication No. 2009-080778
Patent Literature 5: National Patent Publication No. 2005-536795
Patent Literature 6: National Patent Publication No. 2006-516061

### DISCLOSURE OF THE INVENTION

### Problems to be Solved by the Invention

A first problem of the aforementioned related arts is to have to preliminarily create a profile in order to use a system. A degree of familiarity of an operator increases with experience, thus, over time, the items that the operator can correspond more as a teaching side than a learning side increase. Accordingly, the profile continuously needs to be updated.

A second problem of the aforementioned related arts is that it is extremely difficult to describe in a profile a degree of familiarity of a minute area such as a specific function in programming. Here, programming mainly means a coding work in writing a program. The reason why it is extremely difficult is that items to be described in a profile vary depending on a person, and that if items are subdivided, an amount of description increases and it takes too much time. Subdividing items mean dividing items to details in a stepwise fashion, for example, a big headline, a medium headline and a small headline.

The present invention was made in light of the aforementioned problems and is intended to provide a collaborative development support system, a collaborative development support method and a recording medium that establish a database that can deal with a change of a degree of familiarity of an operator.

### Means for Solving the Problems

A collaborative development support system according to a first aspect of the present invention is characterized by including:

information acquisition means configured to acquire operation history information that associates each of operation histories of input devices of terminals by a plurality of operators with operation time of each of the input devices, as well as identification code information associated with each of the plurality of operators;

dividing means configured to divide the operation history information acquired by the information acquisition means into operation groups, each being a set of consecutive operations, according to a predetermined condition;

calculation means configured to set as an index at least one of a speed at which the input device was operated, a correction operation that is an action to correct operation of the operator and an operation including an invalid operation that is not accompanied by an input, and to calculate a degree of familiarity represented by the index for each of the operation groups into which the operation history information was divided by the dividing means; and

storage means configured to store the operation history information and identification code information acquired by the information acquisition means and the degree of familiarity calculated by the calculation means in such a way that the operation history information and identification code information are associated with the degree of familiarity.

A collaborative development support method according to a second aspect of the present invention is performed by a server that receives operation inputs from a plurality of operators, the method is characterized by including:

an information acquisition step to acquire operation history information that associates each of operation histories of input devices of terminals by a plurality of operators with operation of each of the input devices, as well as identification code information associated with each of the plurality of operators;

a dividing step to divide the operation history information acquired by the information acquisition means into operation groups, each being a set of consecutive operations, according to a predetermined condition;

a calculation step to set an index at least one of a speed at which the input device was operated, a correction operation that is an action to correct operation of the operator and an operation including an invalid operation that is not accompanied by an input, and to calculate a degree of familiarity represented by the index for each of the operation groups into which the operation history information was divided at the dividing step; and

a storage step to store the operation history information and identification code information acquired at the information acquisition step and the degree of familiarity calculated at the calculation step in an operation history database in such a way that the operation history information and identification code information are associated with the degree of familiarity.

A computer-readable recording medium according to a third aspect of the present invention records a program that have a computer function as:

information acquisition means configured to acquire operation history information that each of operation histories of input devices of terminals by a plurality of operators with operation time of each of the input devices, as well as identification code information associated with each of the plurality of operators;

dividing means configured to divide the operation history information acquired by the information acquisition means into operation groups, each being a set of consecutive operations, according to a predetermined condition;

calculation means configured to set an index at least one of a speed at which the input device was operated, a correction operation that is an action to correct operation of the operator and an operation including an invalid operation that is not accompanied by an input, and to calculate a degree of familiarity represented by the index for each of the operation groups into which the operation history information wan divided by the dividing means; and

storage means configured to store the operation history information and identification code information acquired by the information acquisition means and the degree of familiarity calculated by the calculation means in an operation history database in such a way that the operation history information and identification code information are associated with the degree of familiarity.

### Effects of the Invention

According to the present invention, a database can be established that can deal with a change of a degree of familiarity of an operator.

### BRIEF DESCRIPTION OF DRAWINGS

FIG. 1 is a block diagram illustrating a configuration example of a collaborative development support system according to a first embodiment of the present invention;

FIG. 2 is a table illustrating an example of operation history information

FIG. 3 is a flow chart illustrating one example of an information acquisition operation in the collaborative development support system according to the first embodiment;

FIG. 4 is a flow chart illustrating one example of a collaborative development support operation in the collaborative development support system according to the first embodiment;

FIG. 5 is a block diagram illustrating a configuration example of a collaborative development support system according to a second embodiment of the present invention;

FIG. 6 is a table illustrating an example of operation history information;

FIG. 7 is a table illustrating an example of a length of a character string and words corresponding to the length;

FIG. 8 is a flow chart illustrating an example of a collaborative development support operation in the collaborative development support system according to the second embodiment;

FIG. 9 is a flow chart illustrating one example of an information presentation operation of the collaborative development support system according to the second embodiment;

FIG. 10 is a block diagram illustrating a configuration example of a collaborative development support system according to a third embodiment of the present invention;

FIG. 11 are diagrams illustrating an example of operation history information;

FIG. 12 is a flow chart illustrating one example of a collaborative development support operation of the collaborative development support system according to the third embodiment;

FIG. 13 is a block diagram illustrating a configuration example of a collaborative development support system according to a fourth embodiment of the present invention;

FIG. 14 is a flow chart illustrating one example of a collaborative development support operation of the collaborative development support system according to the fourth embodiment; and

FIG. 15 is a block diagram illustrating one example of a hardware configuration of a collaborative development support system.

### BEST MODE FOR CARRYING OUT THE INVENTION

Hereinafter, embodiments of the present invention will be described in detail with reference to drawings. In drawings, an identical or corresponding portion is marked with a same reference number.

In the present invention, a degree of familiarity means a degree representing how much an operator learns a target task to be done such as how to operate an input device, and an operator with a higher degree is more familiar with a target area. For example, in developing software for performing some processing, a speed of operation, the number of correction operations, and the number of invalid operations have been found as an index of a degree of familiarity. An operator with a faster operation, less correction operations and less invalid operations has a higher a degree of familiarity, and therefore is estimated to be familiar with software development that requires the target processing.

### First Embodiment

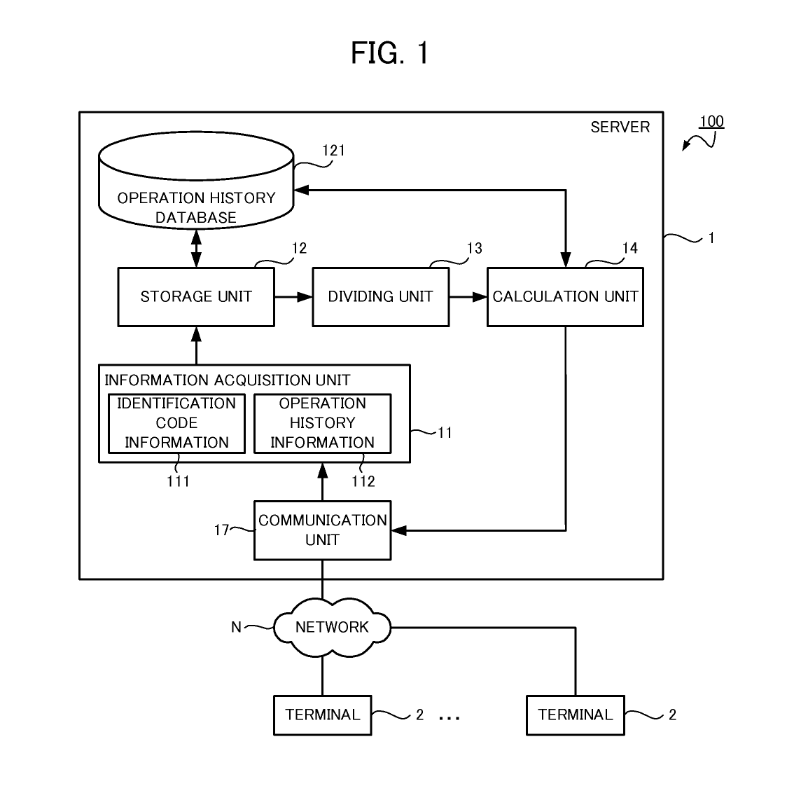

A collaborative development support system 100 according to a first embodiment of the present invention is composed of a server 1 and a plurality of terminals 2 that are connected via a network N, as illustrated in FIG. 1. The server 1 includes an information acquisition unit 11, a storage unit (recording unit) 12, a dividing unit 13, a calculation unit 14, a communication unit 17 and an operation history database 121; and the communication unit 17 is connected to the network N. Each of the terminals 2 is an information processing device provided with an input device (a keyboard in the present embodiment). The terminals 2 are connected to the network N via an un-illustrated communication device.

The information acquisition unit 11 of the server 1 acquires, via the communication unit 17 connected to the network N, operation history information 112 including a history of operations inputted from a keyboard of a terminal 2 by an operator, as well as identification code information 111 to identify the terminal 2. A method to acquire the information has two types of methods, that is, a method to sequentially acquire information and a method to acquire when a predetermined amount of operation history has accumulated, the accumulated operation history together as a whole. For example, every time 20 seconds have passed after an operation history is first checked, an operation history of the last 20 seconds is acquired together as a whole. The predetermined amount is not limited to an amount of time, and can be set by the number of operations such as tapping a keyboard or an amount of history information.

The storage unit 12 stores (records) the identification code information 111 and operation history information 112 acquired by the information acquisition unit 11, as operation history data, in the operation history database (hereinafter, referred to as the operation history DB) 121 in such a way that the identification code information 111 is associated with the operation history information 112. The storage unit 12 also stores (records) information of a degree of familiarity that is calculated by the calculation unit 14, which will be described later, together with the operation history data, in the operation history DB 121.

The dividing unit 13 divides an operation history into operation groups, each being a set of consecutive operations. For example, when a program is produced, an amount to be divided may be preliminarily decided as one set, such as from the next line of “END” to “END”, from opening one file to opening another file.

The calculation unit 14 calculates a degree of familiarity that is represented by an index including a speed at which the keyboard of a terminal 2 was operated, a correction operation that is an action to correct an operation and an invalid operation that is an operation unaccompanied by an input, such as moving a pointer. For example, the speed at which the keyboard of a terminal 2 was operated means an average typing time and/or the like. The operation of moving a pointer that is not accompanied by input means the number of operating a cursor key when a screen is scrolled, moving a cursor by mouse operation and/or the like. A method to calculate a degree of familiarity is set to a predetermined method according to, for example, an index for finding the degree of familiarity.

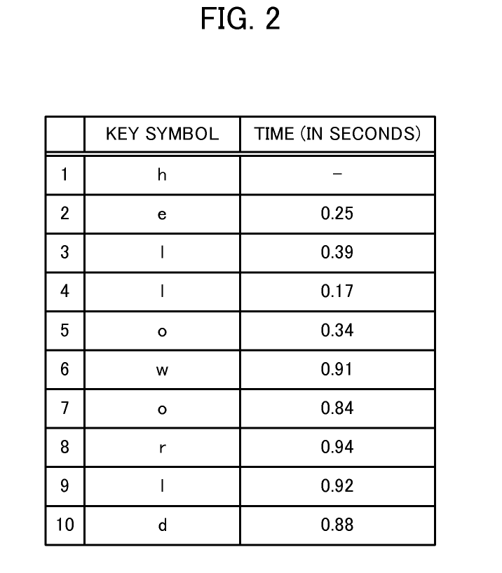

An example of operation history information 112 is illustrated in FIG. 2. The operation history information 112 in FIG. 2 illustrates operation history information when an operator inputs “helloworld” thorough a keyboard. FIG. 2 lists key symbols on the keyboard of a terminal 2 operated by an operator, as well as an amount of time when the key is pressed, in descending order of acquiring information. “helloworld” is an operation history. The key symbol in FIG. 2 is a symbol of the pressed key on the keyboard. The amount of time in FIG. 2 is an amount of time taken from pressing the last key to pressing the next key. FIG. 2 shows that the amount of time for input is less than 0.4 second up to the fifth letter and more than 0.8 second on or after the sixth letter.

Hereinafter, operation of the present embodiment will be specifically described, with respect to a case where programming is performed by inputting through a keyboard as an example.

The collaborative development support system 100 receives an operation of a terminal 2 from the communication unit 17 via the network N and activates the server 1. The information acquisition unit 11 of the server 1 sets a time when an operation of the terminal 2 is first received to a zero time, and then acquires the last operation history information 112 that has been received by and has accumulated in the communication unit 17 together as a whole every time a predetermined amount of time has passed. When the communication unit 17 receives an operation of the terminal 2, the communication unit 17 also receives identification code information 111 of the terminal 2 and the information acquisition unit 11 acquires the identification code information 111.

The information acquisition unit 11 sends the acquired identification code information 111 and operation history information 112 to the storage unit 12. The storage unit 12 associates the acquired identification code information 111 with the acquired operation history information 112 as operation history data thereby to generate or update operation history data in the operation history DB 12. The dividing unit 13 divides the operation history information 112 into operation groups, each being a set of consecutive operations. The calculation unit 14 calculates, for each of the operation groups of the operation history information 112, a degree of familiarity on the basis of an average typing time, the number of pressing a key for correction operation and/or the like in a predetermined method. In doing so, the storage unit 12 also stores the degree of familiarity in association with the operation history data in the operation history DB 121.

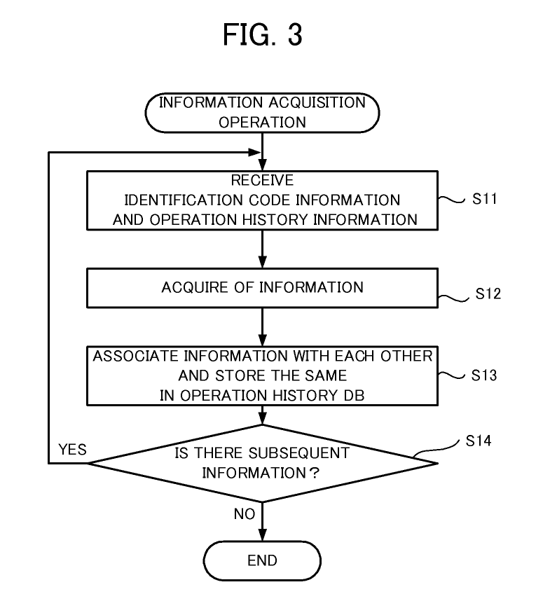

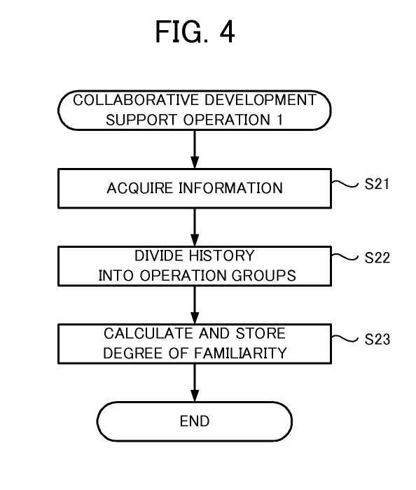

One example of operation of a collaborative development support system according to the present embodiment will be described with reference to flow charts in FIGS. 3 and 4.

In an information acquisition operation in FIG. 3, an operator who uses the collaborative development support system 100 operates a terminal 2. The communication unit 17 of the collaborative development support system 100 receives, via the network N, operation history information 112 that is a history of operations of the terminal 2 and identification code information 111 of the terminal 2 (Step S11). The information acquisition unit 11 acquires these pieces of information received by the communication unit 17 (Step S12). The storage unit 12 stores the identification code information 111 and operation history information 112 received by the information acquisition unit 11 as operation history data in the operation history DB 121 in such a way that the identification code information 111 is associated with the operation history information 112 (Step S13). The collaborative development support system 100, if there is subsequent information to be received by the communication unit 17 (Step S14; YES), returns to Step S11 and receives the information. If there is no subsequent information to be received (Step S14; NO), the information acquisition operation is terminated.

In a collaborative development support operation 1 in FIG. 4, the information acquisition operation in FIG. 3 is first performed thereby to acquire identification code information 111 and operation history information 112 (Step S21). The dividing unit 13 divides the operation history information 112 into operation groups, each being a set of consecutive operations (Step S22). The calculation unit 14 calculates and stores a degree of familiarity for each of the operation groups of the operation history information 112 on the basis of an average typing time, the number of pressing a key for correction operation and/or the like in a predetermined method (Step S23). Then, the collaborative development support operation 1 is terminated.

In the present embodiment, since the collaborative development support system 100 stores an operation history of an operator that uses the collaborative development support system 100 thereby to update data, an operation history database can be established according to a change of a degree of familiarity of the operator. In doing so, a degree of familiarity of the operator is stored with an operation history in the database. Therefore, by using the collaborative development support system 100, information of an operator, operation history information of the operator and information of a degree of familiarity of the operation can be acquired. By referring to the information, a person who can provide responsive support can be easily selected. The operator does not have a trouble creating a database, and exhaustive information on an operation history prevents omission of recording.

Since in the present embodiment, an operator who uses each of the terminals 2 is specified, the operator can be extracted from identification code information 111 associated with each of the terminals 2. In the case where a terminal 2 is shared by a plurality of operators, when each of the operators uses the terminal 2, the operator inputs an identification code such as ID uniquely assigned to each of the operators and the inputted identification code is recognized, thereby enabling the operator to be extracted. The present embodiment has been described with respect to a keyboard input as an example. Any input method can be used, such as the number of click of a mouse, extraction of command information corresponding to a mouse position and an input with a touch pen.

### Second Embodiment

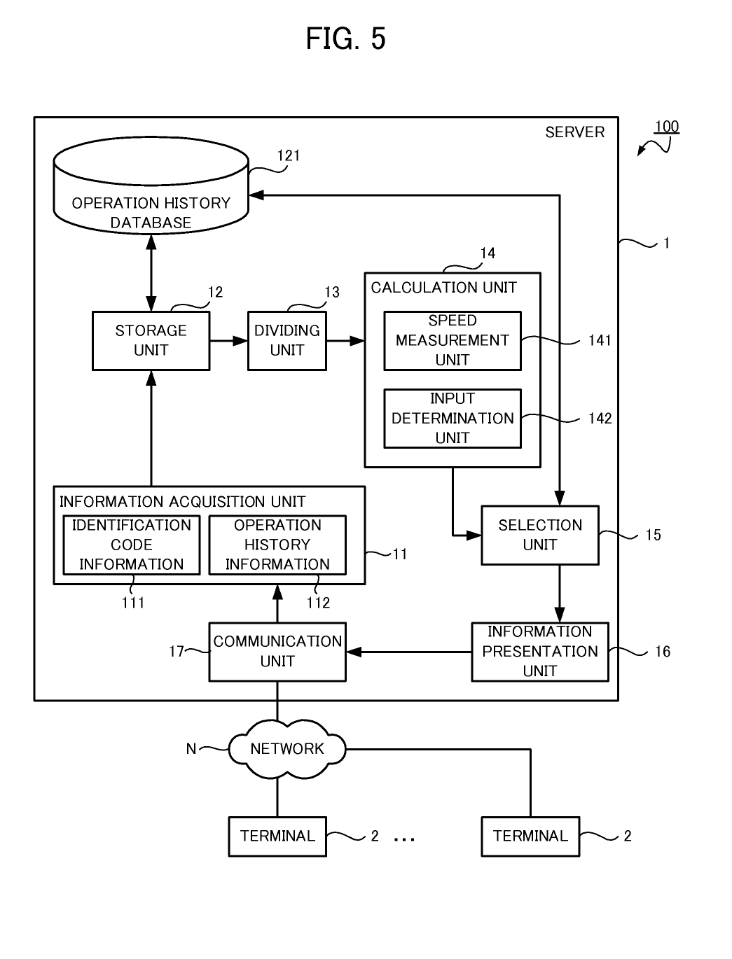

A collaborative development support system according to a second embodiment of the present invention will be described with reference to FIG. 5. The collaborative development support system 100 according to the present embodiment presents to an operator a person with a high degree of familiarity who performed an operation similar to that of the operator as a candidate of a supporter. The collaborative development support system 100 according to the present embodiment includes a selection unit 15 and an information presentation unit 16 in addition to the configuration of the first embodiment. In this collaborative development support system 100, the calculation unit 14 to calculate a degree of familiarity includes a speed measurement unit 141 and an input determination unit 142. The basic configuration is the same as the configuration of the first embodiment.

The speed measurement unit 141 receives operation history information 112 via the dividing unit 13 from the storage unit 12. On the basis of information of a time when a key on a keyboard is pressed, the speed measurement unit 141 measures an amount of time taken until a key is pressed and a speed of tapping a key. A speed of tapping a key is an average typing speed. The average typing speed has two types of typing speed, that is, an average typing speed of each operator and an average typing speed of all operators. A method of comparing an average typing speed may be arbitrarily set to be, for example, a method of comparing an average speed of each operator with an average speed of all operators and a method of comparing a normal average speed of an operator with an average speed of the present typing of the operator.

The input determination unit 142 receives operation history information 112 via the dividing unit 13 from the storage unit 12. The input determination unit 142 determines on the basis of operation history information 112 whether an operation of tapping a key symbol is a correction operation, an invalid operation or not. As described above, a correction operation is an action to correct an operation, and an invalid operation is an operation, such as moving a pointer, that is not accompanied by an input. Specifically, of symbols other than alphabets of key symbols, a history of “BS” indicating an operation of backing by one character or “Esc” indicating an operation of cancelling is determined to be a history of a correction operation. An operation other than a character input and a correction operation, such as a key operation or mouse operation to move a cursor that is not accompanied by input of a character and an operation to cancel a selected command in midstream are determined to be invalid operations. In doing so, a key symbol for which a correction operation or an invalid operation are determined can be arbitrarily selected. In addition to a key operation, a mouse click operation and an operation for printing or overwrite save may be included in invalid operations.

The calculation unit 14 calculates a degree of familiarity of an operator, on the basis of a speed of tapping a key or an average typing time that is measured by the speed measurement unit 141, as well as the number of times of correction operations or invalid operations determined by the input determination unit 142. For example, a result of comparing a typing speed of an operator with an average typing speed of all operators and the number of times of invalid operations of the operator are used. A method to calculate a degree of familiarity can be arbitrarily set to be, for example, a method to compare the last typing speed with a typing speed in a previous history of the same operator and a method to find a change of a rate of correction operations.

The selection unit 15 selects operation history data that matches the operation history information 112 acquired from the operation history DB 121 in a predetermined condition. The predetermined condition can be arbitrarily set. For example, the selection unit 15 may set the condition in a program to be operation history data of which a predetermined number and above of operation histories overlap the operation history information 112 in the operation history DB 121 and therefore is determined to be similar to the operation history information 112 in the operation history DB 121, the operation history data having a large value of a degree of familiarity. With respect to determination of similarity, a condition is previously set. For example, if a rate of overlapping is greater or equal to a predetermined value from recording of inputted characters, they are similar to each other.

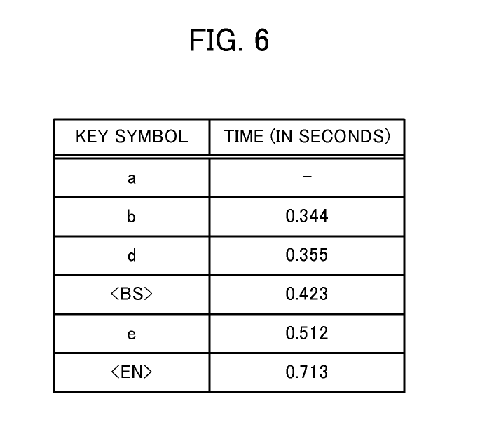

FIG. 6 is an example of operation history information 112. “BS” indicates that a backspace key is pressed to delete a character on the left side of a cursor. “EN” indicates that an enter key is pressed to perform execution, confirmation or linefeed. Time indicates an amount of time from pressing the last key to pressing the present key, as with the first embodiment. With respect to time, information of a time when the present key is pressed may be acquired.

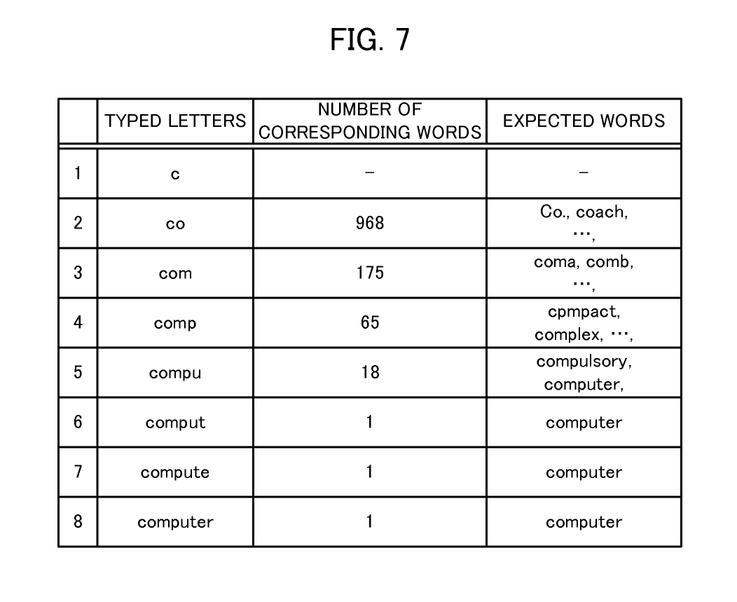

FIG. 7 is an example of a length of a character and words corresponding thereto. A case where “computer” is inputted will be taken as an example. Typed characters indicate a set of key symbols represented in order of key inputs. An expected word indicates a word that is expected to be inputted from character(s) typed. The number of corresponding words indicates the number of words that are expected to be inputted. The more the number of characters that is a length of character string becomes, the less the number of corresponding words becomes. FIG. 7 illustrates an example of words, but a sentence may be used.

For example, in the case where characters that an operator is going to input is “computer”, by using a condition to select data of matching from the first character to the fifth character, the selection unit 15 selects 18 expected words (that is, data). By using a condition to select data of matching six characters, the selection unit 15 selects “computer” that is one expected word. Further, the selection unit 15 extracts operators having a history of inputting the word from operation history data, on the basis of identification code information. In doing so, by comparing a degree of familiarity of the operator with a degree of familiarity of the extracted operators, only operators with a higher degree of familiarity can be selected.

The information presentation unit 16 converts the operation history data selected by the selection unit 15 to data that can be presented including identification code information 111 and sends the converted data via the communication unit 17 to the terminal 2. For example, a name of an operator represented by an identification code of the extracted identification code information 111 is presented on a screen to an operator that uses the collaborative development support system 100. A degree of familiarity calculated by the calculation unit 14 may be presented together with the name.

Hereinafter, an operation to calculate a degree of familiarity and an operation to present information in the collaborative development support system 100 according to the present embodiment will be described.

First, a case where the speed measurement unit 141 of the calculation unit 14 operates will be described. The calculation unit 14 receives information on operation groups from the dividing unit 13 and calculates a degree of familiarity for each of the operation group of operation history information 112. The speed measurement unit 141 extracts an operation included in the operation group from operation history data in the operation history DB 121 and a time when the operation is performed. Then, the speed measurement unit 141 converts the time to a form that is necessary for calculation such as an amount of time taken for typing, according to a condition to calculate a degree of familiarity.

The calculation unit 14 receives the information from the speed measurement unit 141 and calculates a degree of familiarity on the basis of a predetermined condition. For example, a case where “helloworld” is inputted in FIG. 2 will be described. In the present embodiment, a degree of familiarity is set to be a rate of the number of times of typing within a reference typing time to the number of times of all operations. The reference typing time is set to be 0.4 second. First, the calculation unit 14 determines if a typing time of each operation is within 0.4 second, finds the number of times of all operations and the number of times of typing within the reference typing time thereby to calculate a rate. Since the total number of times of operations is ten and the number of times of typing within the reference typing time is four, a degree of familiarity is 40%.

Next, a case where the input determination unit 142 of the calculation unit 14 operates will be described. The calculation unit 14 receives information on operation groups from the dividing unit 13 and calculates a degree of familiarity for each of the operation group of the operation history information 112. The input determination unit 142 extracts operations included in the operation group from operation history data of the operation history DB 121. Then, the calculation unit 14 determines, on the basis of a condition to calculate a degree of familiarity, whether a key symbol in an history of pressing a keyboard is an correction operation, an invalid operation, or not. The calculation unit 14 calculates a degree of familiarity on the basis of information of the input determination unit 142.

As an example in FIG. 6, the input determination unit 142 receives an operation history of pressing a keyboard in order of “a”, “b”, “d”, “BS”, “e” and “EN”, and determines whether the operation is a correction operation or not on the basis of a condition previously programmed. In the present embodiment, since a condition to determine a correction operation is an operation history of “BS” and “Esc”, “BS” corresponds to a correction operation in FIG. 6. The input determination unit 142 sends information indicating that there is a correction operation to the calculation unit 14.

The calculation unit 14 calculates a degree of familiarity on the basis of the predetermined condition. For example, the condition is previously set such that a degree of familiarity is found by a rate of the number of times of operations other than correction operations to the total number of times of operations. The condition is also set such that invalid operations are not included in the number of times of operations. First, the calculation unit 14 finds the total number of times of operations, the number of times of correction operations and the number of times of invalid operations, and calculates the number of times of operations other than correction operations. Next, the calculation unit 14 calculates a rate of the number of times of operations other than correction operations to the total number of times of operations. Since the number of times of invalid operations is not included in the total number of times of operations, the total number of times of operations is six and the number of times of operations other than correction operations is five, and therefore a degree of familiarity is 83.3%.

The selection unit 15 selects, for operation history information 112, operation history data that fulfills a predetermined condition from the operation history DB 121. Then, the selection unit 15 extracts identification code information from the operation history data and generates presentation data in the form of presentation to an operator at the information presentation unit 16, and sends the presentation data to the communication unit 17. The communication unit 17 presents information via the network N to a terminal 2. Information presented at this time includes identification code information 111 corresponding to the operation history selected by the selection unit 15, operation history information 112 thereof and the name and degree of familiarity of an operator having the identification code information 111.

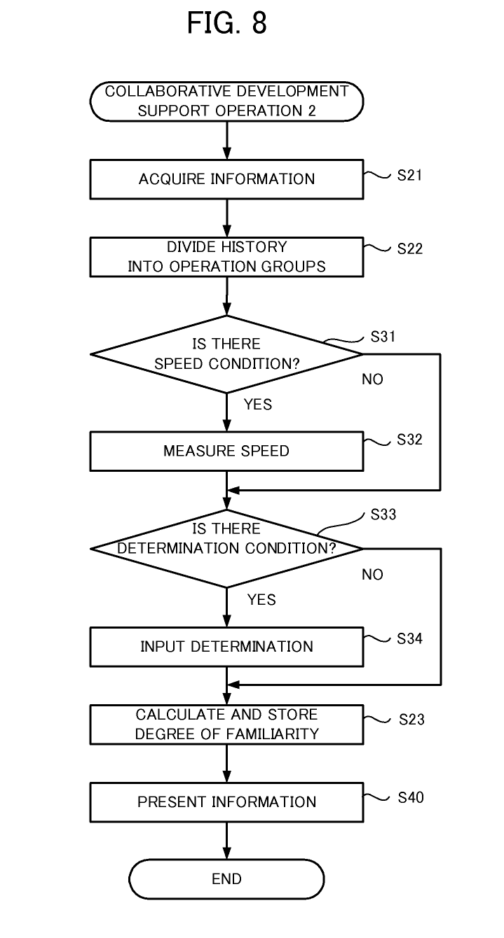

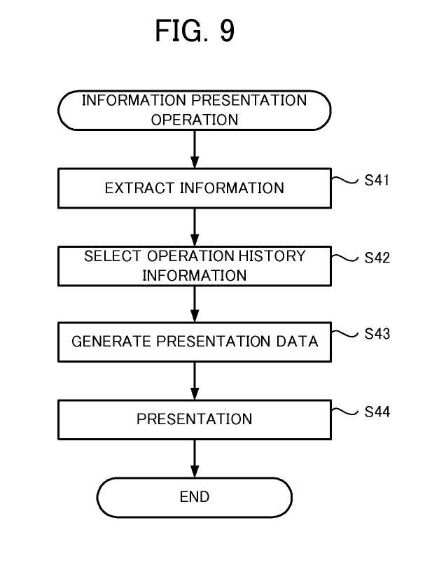

FIGS. 8 and 9 are flow charts illustrating one example of operation of the collaborative development support system according to the second embodiment. FIG. 8 illustrates a collaborative development support operation 2 and FIG. 9 illustrates an information presentation operation. An information acquisition operation is the same as the operation of the collaborative development support system according to the first embodiment.

In the collaborative development support operation 2 of FIG. 8, information acquisition at Step S21 indicates the information acquisition operation illustrated in FIG. 3. Once the collaborative development support system 100 acquires identification code information 111 and operation history information 112 (Step S21), the dividing unit 13 divides the operation history information 112 into operation groups, each being a set of consecutive operation (Step S22).

The calculation unit 14 determines whether a condition to calculate a degree of familiarity includes a condition of a typing speed of an operator (Step S31). If a condition of the typing speed is included (Step S31; YES), the speed measurement unit 141 measures a typing speed (Step S32). If a condition of the typing speed is not included (Step S31; NO), processing proceeds to Step S33. The calculation unit 14 determines whether a predetermined condition to calculate a degree of familiarity includes a condition of input determination such as correct or incorrect of an inputted content (Step S33). If a condition of input determination is included (Step S33; YES), the input determination unit 142 determines an inputted content (Step S34). The calculation unit 14 calculates a degree of familiarity for each of the operation groups of the operation history information 112 in a predetermined method on the basis of data of a speed measured by the speed measurement unit 141 and data of input determination performed by the input determination unit 142 and stores the calculated degree of familiarity in the storage unit 12 (Step S23). If a condition of input determination is not included (Step S33; NO), processing proceeds to Step S23. After a degree of familiarity is calculated and stored at Step S23, information is presented (Step S40). Then, the collaborative development support operation 2 is terminated.

An information presentation operation in FIG. 9 indicates the operation at Step S40 of the collaborative development support operation 2 in FIG. 8. The collaborative development support system 100 extracts identification code information 111, operation history information 112 and information of a degree of familiarity (Step S41). Then, the selection unit 15 selects operation history data of an operation group corresponding to the acquired information from the operation history DB 121 (Step S42). The information presentation unit 16 generates presentation data including identification code information 111 (Step S43) and the communication unit 17 sends the presentation data via the network N to a terminal 2, where the presentation data is presented (Step S44). Then, the information presentation operation is terminated.

According to the present embodiment, since an operation history of an operator who uses the collaborative development support system 100 is stored thereby to update data, an operation history database can be established according to a change of a degree of familiarity of the operator. Since for each work, information on a person who is familiar with the work can be presented, an operator can know the person who is familiar with the work. Further, by calculating and comparing a degree of familiarity, a person who is more familiar with the work can be selected. As a result, a person who can provide responsive support can be selected and an operator can be supported by the person with a higher degree of familiarity.

In the present embodiment, determination of similarity of operation histories performed by the selection unit 15, that is, matching of data stored in a database of the collaborative development support system 100 and an operation history of an operator, can be arbitrarily set. By setting an amount of operation history data to be used for matching to a predetermined amount of time from the beginning of an operation history or a predetermined number of characters, support suitable for an operator can be realized. For example, by increasing a predetermined number of characters, the number of matching operation histories decreases and the number of operators corresponding to the operation histories also decreases, but an operator whose operation history more matches can be extracted and selected. Meanwhile, by decreasing a predetermined number of characters, the number of matching operation histories increases and the number of operators corresponding to the operation histories also increases, and therefore more operators can be presented to an operator who uses the collaborative development support system 100 and the operator can select a supporter the operator thinks preferable among a plurality of corresponding supporters. When operators who are candidates for a supporter are presented, their operation history information and degree of familiarities also may be disclosed.

### Third Embodiment

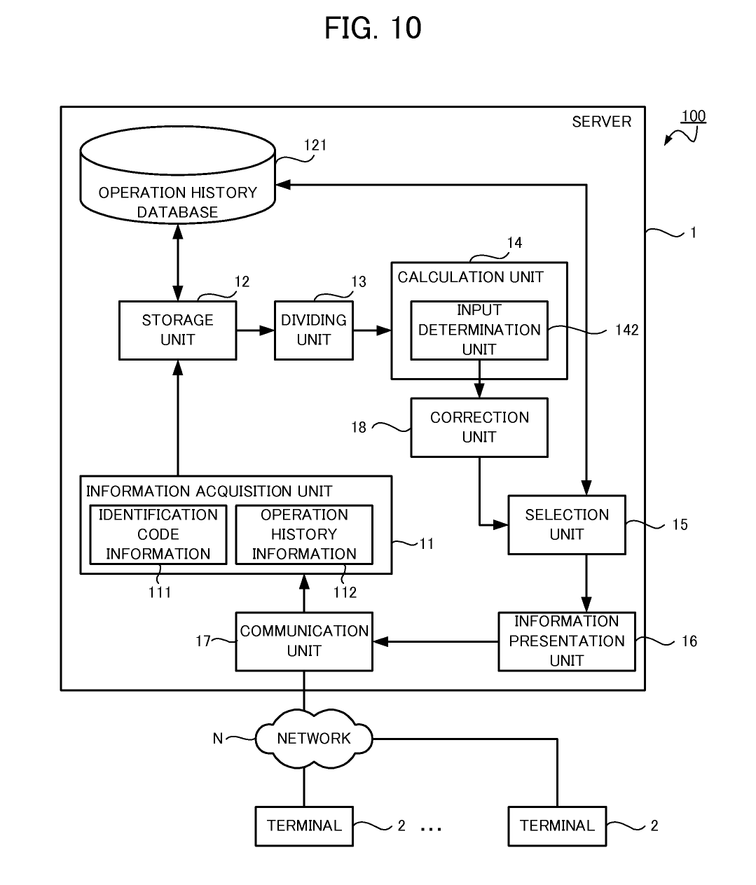

A collaborative development support system according to a third embodiment of the present invention will be described with reference to FIG. 10. The collaborative development support system 100 according to the present embodiment analyses an operation history of an operator thereby to exclude a possibility of an operation error and then determines similarity of operation histories. The collaborative development support system 100 according to the present embodiment includes a correction unit 18 in addition to the configuration of the second embodiment.

The correction unit 18 generates, for an operation that was determined to be a correction operation by the input determination unit 142, a correction history that reflects content of the operation. The correction unit 18 also generates, for an operation that was determined to be an invalid operation, a correction history in which the invalid operation is excluded. An expected input error, such as misspelling of English words and differentiation between capital letters and small letters, may be reflected.

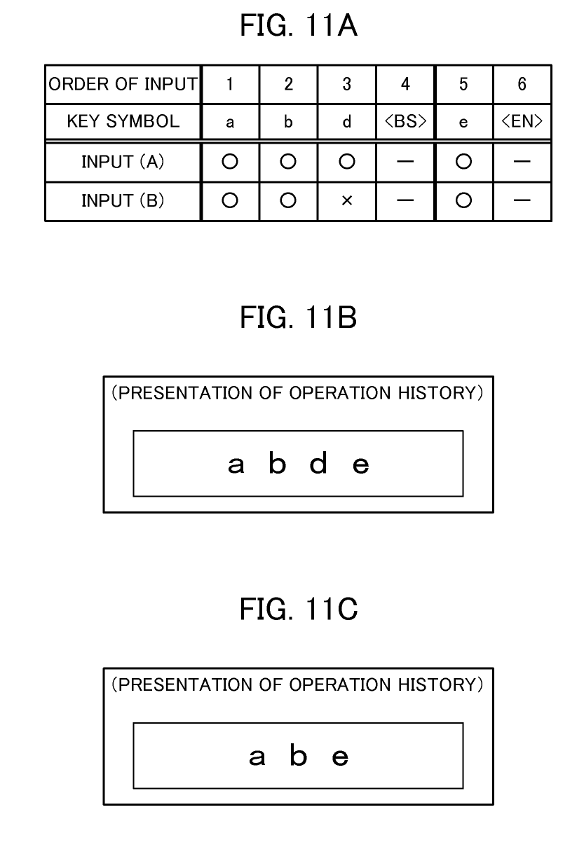

An example of operation history information 112 illustrated in FIG. 11 are an example of a case where a terminal 2 operated by an operator is a keyboard, and the same operation history as the operation history of the first embodiment. In FIG. 11A, an input (A) is a case where recording is performed only when a key symbol of an inputted operation history is any of a character string, and the operation history of the case is illustrated in FIG. 11B. In FIG. 11A, an input (B) is a case where recording is performed reflecting a function key of a key symbol of an inputted operation history, and the operation history of the case is illustrated in FIG. 11C. Since “BS” is a backspace key to delete a character on the left side of a cursor, a character “d” is deemed to be inputted by mistake. Although a character string of an actual operation is illustrated in FIG. 11B, a character string to be inputted is illustrated in FIG. 11C.

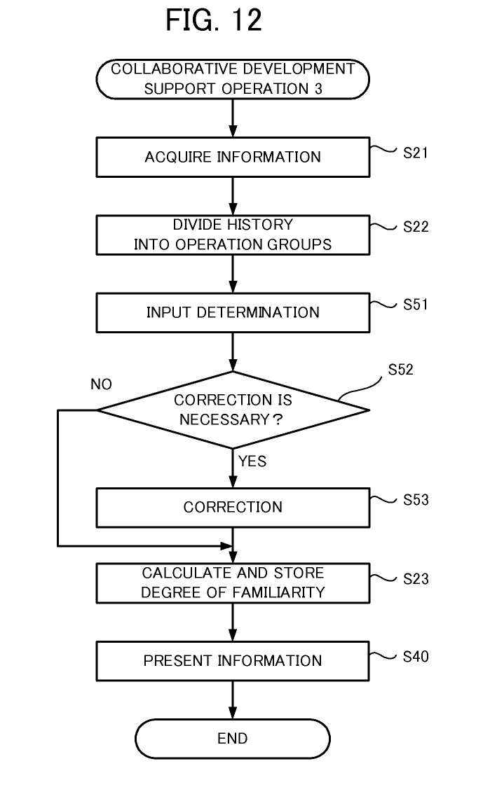

One example of the collaborative development support operation in the collaborative development support system according to the present embodiment will be described with reference to a flow chart in FIG. 12. An information acquisition operation is the same as the information acquisition operation in FIG. 3 described in the first embodiment, and an information presentation operation is the same as the information presentation operation in FIG. 9 described in the second embodiment.

Information acquisition at Step S21 indicates the information acquisition operation in FIG. 3 described in the first embodiment. Once the information acquisition unit 11 acquires identification code information 111 and operation history information 112 (Step S21), the dividing unit 13 divides the operation history information 112 into operation groups, each being a set of consecutive operations (Step S22).

The input determination unit 142 determines an inputted content (Step S51). Determination at Step S51 is whether there is a correction operations or an invalid operation in an operation history. If there is a correction operation or an invalid operation in an operation history, correction is necessary (Step S52; YES) and the operation history is corrected by reflecting a correction operation or excluding an invalid operation, depending on a function of the key symbol (Step S53) and then processing proceeds to Step S23. At Step S53, for example, in the aforementioned example in FIG. 11, if an operation history has “BS”, an operation history “d” just before “BS” is deleted. If correction is not necessary (Step S52; NO), processing proceeds to Step S23.

The calculation unit 14 calculates a degree of familiarity for each of the operation groups of the operation history information 112 on the basis of corrected operation history information in a predetermined method and stores the calculated degree of familiarity (Step S23). Then, information is presented (Step S40) and the collaborative development support operation 3 is terminated.

The corrected operation history information that was corrected and generated at Step S53 may be stored in the operation history DB 121. If there is no need to present information at Step S40, the collaborative development support operation 3 may be terminated after a degree of familiarity is calculated and stored at Step S23.

According to the present embodiment, since the collaborative development support system 100 determines an input error in an inputted operation history and then searches an operation history similar to the inputted operation history, matching of operation histories and narrowing down of supporters with a high degree of familiarity can be performed with a high accuracy in development support. As a result, a supporter who is more suitable to support an operator can be extracted, allowing for development support.

Although not described in the present embodiment, by taking a history to be determined as a correction operation or an invalid operation into consideration, similarity of operation histories is determined not only by reflecting or excluding the history but also by including a predetermined ambiguity. Ambiguity includes that matching is determined by allowing for misspelling and that capital letters and small letters are not differentiated. By taking ambiguity into consideration, operation history data that is similar to or matches operation history information is selected from the operation history database, thereby performing development support that is more suitable to an operator.

### Fourth Embodiment

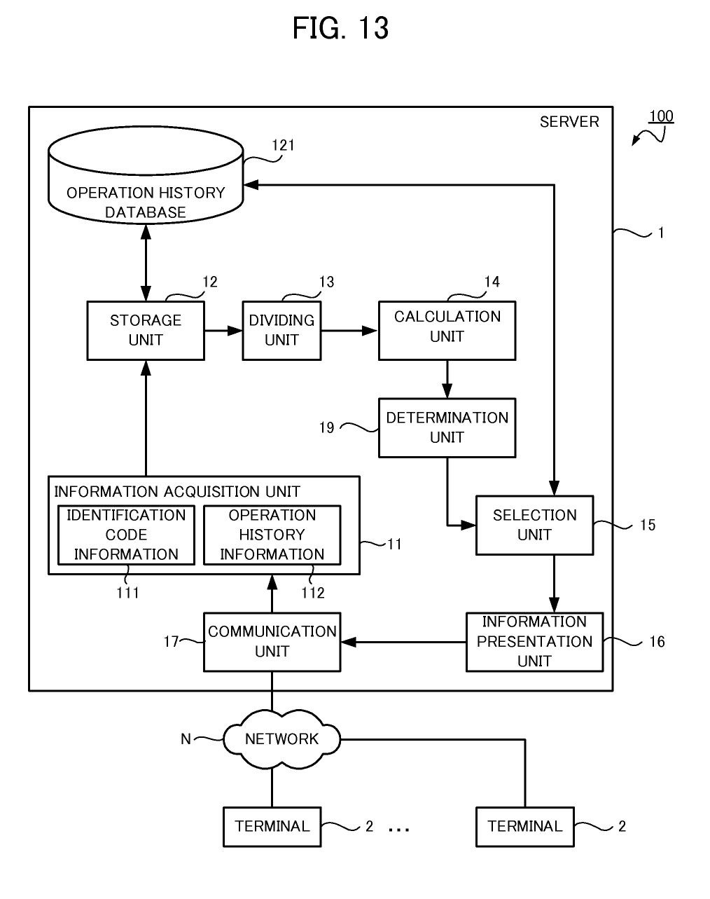

FIG. 13 is a block diagram illustrating a configuration example of a collaborative development support system according to a fourth embodiment of the present invention. The collaborative development support system 100 according to the present embodiment determines whether to present a supporter on the basis of a degree of familiarity of an operation performed by an operator. The collaborative development support system 100 according to the present embodiment includes a determination unit 19 in addition to the configuration of the second embodiment.

The determination unit 19 determines whether a degree of familiarity calculated by the calculation unit 14 is within a predetermined range. If the degree of familiarity is within the predetermined range, it is determined that support is necessary. Development support may be provided to not only an operator who is determined to have a low degree of familiarity but also an operator who is determined to have a high degree of familiarity. When support is provided to the operator with a high degree of familiarity, support may be limited to a case where a degree of familiarity of an operator to be presented for support is sufficiently higher than a degree of familiarity of an operator to be supported. In determination by the determination unit 19, criteria for determining whether support is necessary or not and a predetermined range to be used for the determination are previously programmed in the collaborative development support system 100 on the basis of data provided by statistics and/or the like.

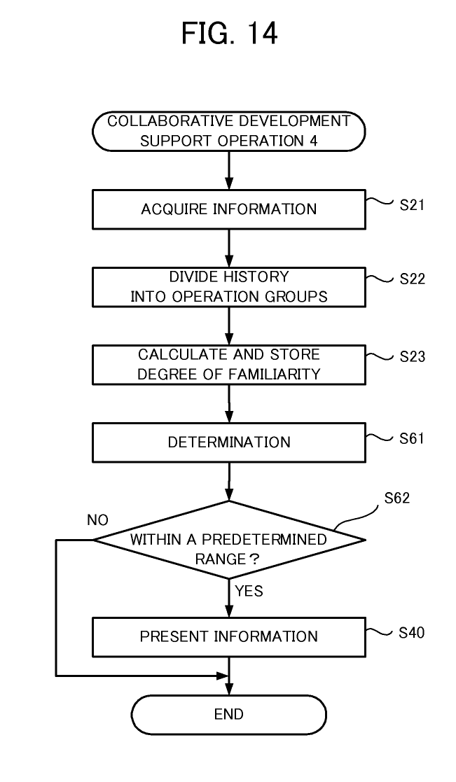

FIG. 14 is a flow chart illustrating one example of a collaborative development support operation of the collaborative development support system according to the present embodiment. An information acquisition operation is the same as the information acquisition operation in FIG. 3 described in the first embodiment and an information presentation operation is the same as the information presentation operation in FIG. 9 described in the second embodiment.

Information acquisition at Step S21 indicates the information acquisition operation in FIG. 3. Once the information acquisition unit 11 acquires identification code information 111 and operation history information 112 (Step S21), the dividing unit 13 divides the operation history information 112 into operation groups, each being a set of consecutive operations (Step S22). The calculation unit 14 calculate a degree of familiarity for each of the operation groups of the operation history information 112 on the basis of an average typing time, the number of times of pressing a key for a correction operation and/or the like in a predetermined method and stores the calculated degree of familiarity (Step S23).

Then, the determination unit 19 determines a degree of familiarity, by comparing a predetermined set value with the calculated value (Step S61). If the degree of familiarity is within the predetermined range (Step S62; YES), the determination unit 19 determines that support is necessary, processing proceeds to information presentation (Step S40). If the degree of familiarity is not within the predetermined range (Step S62; NO), the determination unit 19 determines that support is not necessary, the processing is terminated. Then, the collaborative development support operation 4 is terminated.

According to the present embodiment, the collaborative development support system 100 can calculate a degree of familiarity of an operator and support the operator according to need. Further, the collaborative development support system 100 can take a degree of familiarity of an operator into consideration and recommend a more suitable person. Further, the collaborative development support system 100 determines whether development support is necessary and presents a supporter only when the support is necessary, thereby saving waste of computer resources as much as possible.

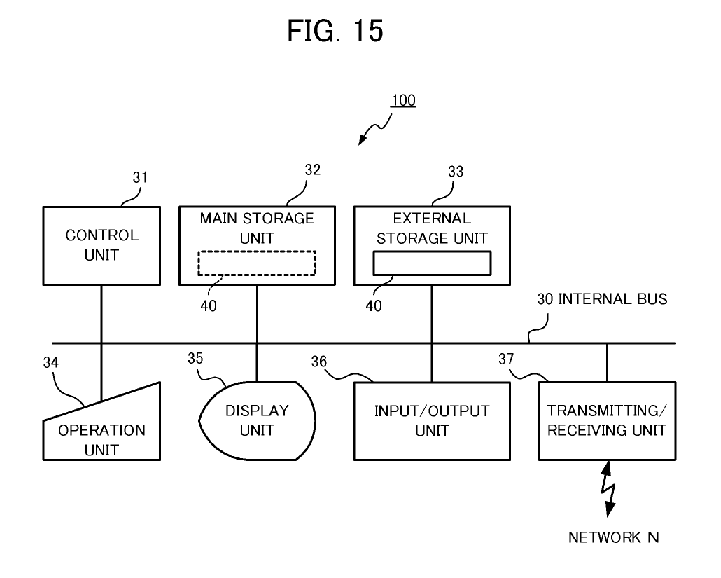

FIG. 15 is a block diagram illustrating an example of a hardware configuration of the collaborative development support system illustrated in FIG. 1, 5, 10 or 13. The collaborative development support system 100 includes a control unit 31, a main storage unit 32, an external storage unit 33, an operation unit 34, a display unit 35, an input/output unit 36 and a transmitting/receiving unit 37, as illustrated in FIG. 15. The main storage unit 32, external storage unit 33, operation unit 34, display unit 35, input/output unit 36 and transmitting/receiving unit 37 all are connected via an internal bus 30 to the control unit 31.

The control unit 31 is composed of a central processing unit (CPU) and/or the like, and performs each processing by each of the information acquisition unit 11, storage unit 12, dividing unit 13, calculation unit 14, selection unit 15, information presentation unit 16, communication unit 17 and the like of the collaborative development support system 100, according to a control program 40 stored in the external storage unit 33.

The main storage unit 32 is composed of a random-access memory (RAM) and/or the like, loads the control program 40 stored in the external storage unit 33 and is used as a work area of the control unit 31.

The external storage unit 33 is composed of a nonvolatile memory such as a flash memory, a hard disk, a digital versatile disc random-access memory (DVD-RAM) and a digital versatile disc rewritable (DVD-RW) and previously stores a program to have the control unit 31 perform processing of the collaborative development support system 100. In addition, the external storage unit 33 supplies data stored in this program to the control unit 31 according to an instruction from the control unit 31 and stores data supplied from the control unit 31.

The storage unit 12 and operation history DB 121 of the collaborative development support system 100 are configured in the external storage unit 33. In some cases, the operation history DB 121 is configured in the external storage unit 33.

The operation unit 34 is composed of a keyboard, a pointing device such as a mouse and/or the like and an interface unit to connect the keyboard, pointing device and/or the like to the internal bus 30. An operation of an operator is inputted via the operation unit 34 and is supplied to the control unit 31.

The display unit 35 is composed of a cathode ray tube (CRT), a liquid crystal display (LCD) or the like, and displays operation history information and the like.

The input/output unit 36 is composed of a serial interface or a parallel interface. The input/output unit 36 is connected to a terminal 2 if the system is accompanied by the terminal 2.

The transmitting/receiving unit 37 is composed of a network terminal unit or a wireless communication device that is connected to the network N and a serial interface or a local area network (LAN) interface that is connected to the network terminal unit or wireless communication device. The transmitting/receiving unit 37 transmits and receives information such as an operation history via the network N. If a terminal 2 is a terminal device independent from the collaborative development support system 100, the collaborative development support system 100 connects via the transmitting/receiving unit 37 through the network N to the terminal 2.

The control program 40 uses the control unit 31, main storage unit 32, external storage unit 33, operation unit 34, display unit 35, input/output unit 36 and transmitting/receiving unit 37 as resources thereby to perform processing by each of the information acquisition unit 11, storage unit 12, dividing unit 13, calculation unit 14, selection unit 15, information presentation unit 16, and communication unit 17 of the collaborative development support system 100 illustrated in FIG. 1, 5, 10 or 13.

The aforementioned hardware configuration and flow charts are examples, and can be arbitrarily changed and modified.

A main section to perform collaborative development processing that is composed of the information acquisition unit 11, storage unit 12, dividing unit 13, calculation unit 14, selection unit 15, information presentation unit 16, communication unit 17 and the like can be realized by a common computer system, not by a dedicated system. For example, a collaborative development support system may be configured in such a way that a computer program for performing the aforementioned operation is stored and distributed in a computer-readable recording medium (such as a flexible disk, CD-ROM, DVD-ROM) and is installed into a computer thereby to perform the aforementioned processing. A collaborative development support system may be configured in such a way that the computer program is stored in a storage device disposed in a server system on a communication network such as the Internet, and is downloaded by a common computer system.

In the case where a collaborative development support system is realized by dividing an operating system (OS) and an application program or by cooperation of an OS and an application program, only an application program may be stored in a recording medium or a storage device.

A computer program can be superimposed on a carrier wave and distributed via a communication network. For example, the computer program may be placed on a bulletin board system (BBS) on a communication network and distributed via the network. Then, the computer program may be started and executed as with other application programs under the control of the OS thereby to perform the aforementioned processing.

Part or all of the aforementioned embodiments can be described in the below mentioned additional statements, but are not limited to the below mentioned additional statements.

(Additional Statement 1)

A collaborative development support system including:

information acquisition means configured to acquire operation history information that associates each of operation histories of input devices of terminals by a plurality of operators with operation time of each of the input devices, as well as identification code information associated with each of the plurality of operators;

dividing means configured to divide the operation history information acquired by the information acquisition means into operation groups, each being a set of consecutive operations, according to a predetermined condition;

calculation means configured to set as an index at least one of a speed at which the input device was operated, a correction operation that is an action to correct an operation of the operator and an operation including an invalid operation that is not accompanied by an input, and to calculate a degree of familiarity represented by the index for each of the operation groups into which the operation history information was divided by the dividing means; and

storage means configured to store the operation history information and identification code information acquired by the information acquisition means and the degree of familiarity calculated by the calculation means in an operation history database in such a way that the operation history information and identification code information are associated with the degree of familiarity.

(Additional Statement 2)

The collaborative development support system according to additional statement 1 including:

determination means configured to compare operation history information of an operator who operated the input device with operation history information stored in the operation history database on the basis of a predetermined condition thereby to determine similarity;

selection means to select operation history information stored in the operation history database, the operation history information is information when the similarity determined by the determination means is a predetermined value, and a degree of familiarity calculated on the basis of operation history information stored in the operation history database is higher than a degree of familiarity calculated on the basis of operation history information of the operator who operated the input device in the operation group of operation history information that was subjected to determination; and

presentation means configured to extract, from the operation history database, identification code information of an operator associated with the operation history information selected by the selection means, and to present the identification code information of the operator to the operator who operated the input device.

(Additional Statement 3)

The collaborative development support system according to additional statement 1 including:

input determination means configured to determine a correction operation or an invalid operation on the basis of the operation history information; and

correction means configured to reflect the determined correction operation of the operation history information or exclude the determined invalid operation thereby to generate a corrected operation history.

(Additional Statement 4)

The collaborative development support system according to additional statement 2 including:

input determination means configured to determine a correction operation or an invalid operation on the basis of the operation history information; and

correction means configured to reflect the determined correction operation or exclude the determined invalid operation of operation history information thereby to generate a corrected operation history,

wherein the determination means determines similarity on the basis of the corrected operation history generated by the correction means.

(Additional Statement 5)

A collaborative development support method performed by a server that receives operation inputs from a plurality of operators, the method including:

an information acquisition step to acquire operation history information that associates each of operation histories of input devices of terminals by a plurality of operators with operation of each of the input devices, as well as identification code information associated with each of the plurality of operators;

a dividing step to divide the operation history information acquired by information acquisition means into operation groups, each being a set of consecutive operations, according to a predetermined condition;

a calculation step to set as an index at least one of a speed at which the input device was operated, an correction operation that is an action to correct an operation of the operator and an operation including an invalid operation that is not accompanied by an input, and to calculate a degree of familiarity represented by the index for each of the operation groups into which the operation history information was divided at the dividing step; and

a storage step to store the operation history information and identification code information acquired at the information acquisition step and the degree of familiarity calculated at the calculation step in an operation history database in such a way that the operation history information and identification code information are associated with the degree of familiarity.

(Additional Statement 6)

The collaborative development support method according to additional statement 5 including:

a determination step to compare operation history information of an operator who operated the input device with operation history information stored in the operation history database in a predetermined condition thereby to determine similarity;

a selection step to select the operation history information stored in the operation history database, the operation history information is information when the similarity determined by the determination step is a predetermined value, and, a degree of familiarity of operation history information stored in the operation history database is higher than a degree of familiarity of the operator who operated the operation history information in the operation group of operation history information that was subjected to determination; and

a presentation step to extract, from the operation history database, identification code information of an operator associated with the operation history information selected at the selection step to be stored, and to present the extracted identification code information of the operator to the operator who operated the input device.

(Additional Statement 7)

The collaborative development support method according to additional statement 5 including:

an input determination step to determine a correction operation or an invalid operation on the basis of the operation history information; and

a correction step to reflect the determined correction operation or exclude the determined invalid operation of operation history information at the input determination step thereby to generate a corrected operation history.

(Additional Statement 8)

The collaborative development support method according to additional statement 6 including:

an input determination step to determine a correction operation or an invalid operation on the basis of the operation history information; and

a correction step to reflect the determined correction operation or exclude the determined invalid operation of operation history information at the input determination step thereby to generate a corrected operation history,

wherein the determination step determines similarity on the basis of the corrected operation history generated at the correction step.

(Additional Statement 9)

A computer-readable recording medium recording a program that makes a computer function as:

information acquisition means configured to acquire operation history information that associates each of operation histories of input devices of terminals by a plurality of operators with operation time of each of the input devices, as well as identification code information associated with each of the plurality of operators;

dividing means configured to divide the operation history information acquired by the information acquisition means into operation groups, each being a set of consecutive operations, according to a predetermined condition;

calculation means configured to set an index at least one of a speed at which the input device was operated, a correction operation that is an action to correct an operation of the operator and an operation including an invalid operation that is not accompanied by an input, and to calculate a degree of familiarity represented by the index for each of the operation groups into which the operation history information was divided by the dividing means; and

storage means configured to store the operation history information and identification code information acquired by the information acquisition means and the degree of familiarity calculated by the calculation means in an operation history database in such a way that the operation history information and identification code information are associated with the degree of familiarity.

The present invention is based on Japanese Patent Application No. 2009-253726 filed on Nov. 5, 2009. The entire specification, claims and drawings of Japanese Patent Application No. 2009-253726 are incorporated into this specification by reference.

### INDUSTRIAL APPLICABILITY

The present invention can be applied to collaborative development support of software. The present invention is not limited to this, and can be applied to support for discussion over a network or consensus building.

### EXPLANATION OF REFERENCE NUMERALS

1. server

2. terminal

11. information acquisition unit

12. storage unit

13. dividing unit

14. calculation unit

15. selection unit

16. information presentation unit

17. communication unit

18. correction unit

19. determination unit

100. collaborative development support system

111. identification code information

112. operation history information

121. operation history database (operation history DB)

141 speed measurement unit

142 input determination unit

1-9. (canceled)

10. A collaborative development support system comprising:
an information acquisition unit configured to acquire operation history information that associates each of operation histories of input devices of terminals by a plurality of operators with operation time of each of the input devices, as well as identification code information associated with each of the plurality of operators;
a dividing unit configured to divide the operation history information acquired by the information acquisition unit into operation groups, each being a set of consecutive operations, according to a predetermined condition;
a calculation unit configured to set as an index at least one of a speed at which the input device was operated, a correction operation that is an action to correct an operation of the operator and an operation including an invalid operation that is not accompanied by an input, and calculate a degree of familiarity represented by the index for each of the operation groups into which the operation history information was divided by the dividing unit;
a storage unit configured to store the operation history information and identification code information acquired by the information acquisition unit and the degree of familiarity calculated by the calculation unit in an operation history database in such a way that the operation history information and identification code information are associated with the degree of familiarity;
a determination unit to compare operation history information of an operator who operated the input device with operation history information stored in the operation history database according to a predetermined condition thereby to determine similarity;
a selection unit to select operation history information stored in the operation history database, the operation history information is information when the similarity determined by the determination unit is a predetermined value, and a degree of familiarity calculated on the basis of operation history information stored in the operation history database is higher than a degree of familiarity calculated on the basis of operation history information of the operator who operated the input device in the operation group of operation history information that was subjected to determination; and
a presentation unit configured to extract, from the operation history database, identification code information of an operator associated with the operation history information selected by the selection unit to be stored, and to present the extracted identification code information to the operator who operated the input device,
wherein the input device is a keyboard or a mouse.

11. The collaborative development support system according to claim 10 comprising:
an input determination unit configured to determine an correction operation or an invalid operation on the basis of the operation history information; and
a correction unit configured to reflect the determined correction operation or exclude the determined invalid operation of operation history information at the input determination unit thereby to generate a corrected operation history;
wherein the determination unit determines similarity on the basis of the corrected operation history generated by the correction unit.

12. A collaborative development support method performed by a server that receives operation inputs from a plurality of operators, the method comprising:
an information acquisition step to acquire operation history information that associates each of operation histories of input devices of terminals by a plurality of operators with operation time of each of the input devices, as well as identification code information associated with each of the plurality of operators;
a dividing step to divide the operation history information acquired by the information acquisition step into operation groups, each being a set of consecutive operations, according to a predetermined condition;
a calculation step to set as an index at least one of a speed at which the input device was operated, a correction operation that is an action to correct an operation of the operator and an operation including an invalid operation that is not accompanied by an input, and to calculate a degree of familiarity represented by the index for each of the operation groups into which the operation history information was divided at the dividing step;
a storage step to store the operation history information and identification code information acquired at the information acquisition step and the degree of familiarity calculated at the calculation step in an operation history database in such a way that the operation history information and identification code information are associated with the degree of familiarity;
a determination step to compare operation history information of an operator who operated the input device with operation history information stored in the operation history database according to a predetermined condition thereby to determine similarity;
selection step to select operation history information stored in the operation history database, the operation history information is information when the similarity determined by the determination step is a predetermined value, and a degree of familiarity calculated on the basis of operation history information stored in the operation history database is higher than a degree of familiarity calculated on the basis of operation history information of the operator who operated the input device in the operation group of operation history information that was subjected to determination; and
a presentation step to extract, from the operation history database, identification code information of an operator associated with the operation history information selected at the selection step to be stored, and to present the extracted identification code information to the operator who operated the input device,
wherein the input device is a keyboard or a mouse.

13. The collaborative development support method according to claim 12 comprising:
an input determination step to determine a correction operation or an invalid operation on the basis of the operation history information; and
a correction step to reflect the determined correction operation or exclude the determined invalid operation of operation history information at the input determination step thereby to generate a corrected operation history;
wherein the determination step determines similarity on the basis of the corrected operation history generated at the correction step.

14. A computer-readable recording medium recording a program that makes a computer function as:
an information acquisition unit configured to acquire operation history information that associates each of operation histories of input devices of terminals by a plurality of operators with operation time of each of the input devices, as well as identification code information associated with each of the plurality of operators;
a dividing unit configured to divide the operation history information acquired by the information acquisition unit into operation groups, each being a set of consecutive operations, according to a predetermined condition;
a calculation unit configured to set as an index at least one of a speed at which the input device was operated, a correction operation that is an action to correct an operation of the operator and an operation including an invalid operation that is not accompanied by an input, and to calculate a degree of familiarity represented by the index for each of the operation groups into which the operation history information was divided by the dividing unit;
a storage unit configured to store the operation history information and identification code information acquired by the information acquisition unit and the degree of familiarity calculated by the calculation unit in an operation history database in such a way that the operation history information and identification code information are associated with the degree of familiarity;
determination unit to compare operation history information of an operator who operated the input device with operation history information stored in the operation history database according to a predetermined condition thereby to determine similarity;
selection unit to select operation history information stored in the operation history database, the operation history information is information when the similarity determined by the determination unit is a predetermined value, and a degree of familiarity calculated on the basis of operation history information stored in the operation history database is higher than a degree of familiarity calculated on the basis of operation history information of the operator who operated the input device in the operation group of operation history information that was subjected to determination; and
presentation unit configured to extract, from the operation history database, identification code information of an operator associated with the operation history information selected by the selection unit to be stored, and to present the extracted identification code information to the operator who operated the input device,
wherein the input device is a keyboard or a mouse.
